(19) United States
(12) Patent Application Publication
(10) Pub. No.: US 2026/0111959 A1
(43) Pub. Date: Apr. 23, 2026

(54) SYSTEM AND METHOD FOR LIVING INFLUENCE BONDS

(71) Applicant: George William Bickerstaff, III, Greenwich, CT (US)

(72) Inventor: George William Bickerstaff, III, Greenwich, CT (US)

(21) Appl. No.: 19/377,015

(22) Filed: Nov. 2, 2025

(51) Int. Cl. G06Q 40/04

(52) U.S. Cl. CPC G06Q 40/04

(57) ABSTRACT

A computer-implemented system converts verified digital influence data into blockchain tokens containing cryptographic proofs of authenticity. Each trade executes an atomic royalty payment distributing preset percentages to creators, platforms, and verification oracles. Verified datasets pass through a tokenization module and are listed on decentralized exchanges. All transactions and royalty allocations occur within a single blockchain block for transparency and efficiency. Optional embodiments enable vaulting and fractionalization of tokens into compliant investment instruments, connecting creators, advertisers, and investors in one programmable, auditable ecosystem.

### FIELD OF THE INVENTION

The invention relates to decentralized data tokenization and programmable royalty automation. More particularly, it provides computer-implemented systems and methods for transforming verified digital influence data into tradeable blockchain-based assets and for automatically distributing royalties during each transaction across decentralized networks.

### DEFINITIONS

“Influence Packet”—a digitally signed dataset containing verified creator engagement metrics.
“Verified Oracle”—a cryptographically trusted service that attests to the authenticity of off-chain data and provides proof to on-chain contracts.
“Atomic Execution”—simultaneous completion of interdependent smart-contract functions within a single blockchain block to eliminate partial transaction risk.
“Royalty Graph”—a programmable smart contract that distributes predefined percentages of transaction value among beneficiaries.
“Vault Layer”—a custodial or semi-custodial smart contract that aggregates Influence Tokens and issues 1:1-backed fractionalized investment shares.
“Proof-of-Reserve”—a cryptographically verifiable statement that confirms underlying asset collateralization for fractionalized vaults.

### BACKGROUND OF THE INVENTION

Influence data remains fragmented across closed platforms, impeding verification and fair compensation for creators.

Advertisers depend on unverifiable metrics, and creators rarely capture downstream value as their content is reused or monetized by intermediaries.

While blockchain systems allow token creation, none integrate verified influence tokenization with real-time royalty logic, regulatory readiness, and compliant auditing.

The present invention remedies these limitations by creating a unified, verifiable, and auditable framework that tokenizes creator influence, automates royalties, and maintains transparent, regulator-ready data trails.

### SUMMARY OF THE INVENTION

The invention provides a computer-implemented system that converts verified creator influence data into Influence Tokens carrying cryptographic proof of authenticity.

A Royalty Graph Smart Contract automatically executes royalty payments within the same blockchain block as each trade, distributing preset percentages among creators, platforms, and verification oracles.

The system operates on Ethereum-compatible environments (EVMs) and can optionally aggregate tokens into a Vault Layer that issues compliant, fractionalized financial instruments for investors.

### ADVANTAGES OF THE INVENTION

The invention unifies influence verification, tokenization, royalty automation, and compliance in one interoperable framework.

It guarantees creators perpetual royalty participation, gives advertisers auditable authenticity, and allows investors fractionalized exposure to verified digital influence.

By combining cryptographic proof-of-data, automatic settlements, and proof-of-reserve auditing, the system reduces fraud, accelerates settlement, and strengthens trust in decentralized media markets.

### BRIEF DESCRIPTION OF THE DRAWINGS

FIG. 1—System Architecture (a) Oracle Swarm (b) Price Engine (c) Mint Burn (d) Intent Router (e) Privacy Shield (f) Regulator Lens

FIG. 2—Repricing Loop (a) Metric Collection (b) Swarm Verify (c) Delta Packet (d) Price Update (e) Token Adjust (f) Yield Route

FIG. 3—Coupon Flow (a) Oracle Fees (b) Creator Royalties (c) DAO Treasury (d) Holder Yield (e) DeFi Reinvest (f) Liquidity Balance

FIG. 4—Partner Integration Toolkit Diagram (a) Secure Storage (b) Compliance Logger (c) Transaction Recording (d) Compliance Checker (e) Timestamp Module (f) Log Encryption

FIG. 5—Token Lifecycle (a) Creator Onboard (b) Market Listing (c) Price Trading (d) Burn Redeem (e) Tax Event (f) Audit Trail

FIG. 6—Cross-Chain (a) Multi-Chain Deploy (b) Oracle Sync (c) Liquidity Bridge (d) Yield Interop (e) Unified Lens (f) Failover Redundancy

### DETAILED DESCRIPTION OF THE INVENTION

### System Overview

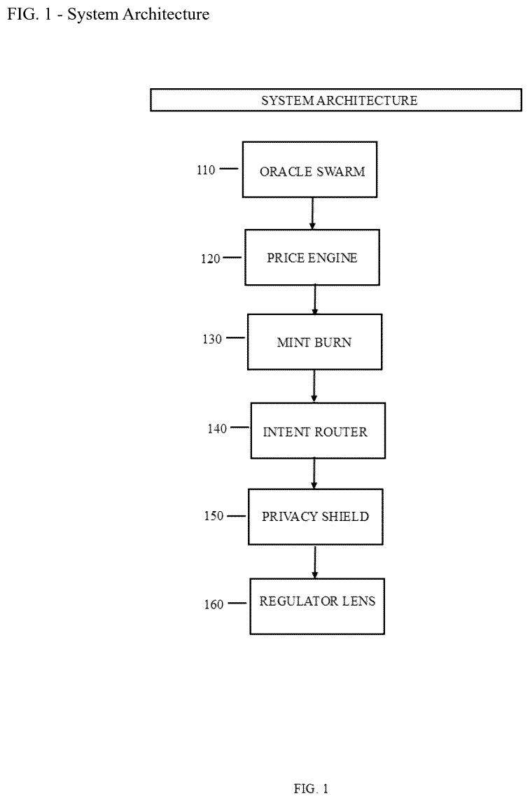

Referring to FIG. 1, the system comprises a modular architecture including an Oracle Swarm for distributed verification, a Price Engine for dynamic valuation based on influence metrics, Mint Burn mechanisms for token issuance and redemption, an Intent Router for transaction orchestration, a Privacy Shield for data protection, and a Regulator Lens for compliance monitoring.

Each component operates via blockchain-executable code communicating through signed API calls.

The modular design enables upgrades for evolving standards and jurisdictional compliance.

### Influence Data Verification

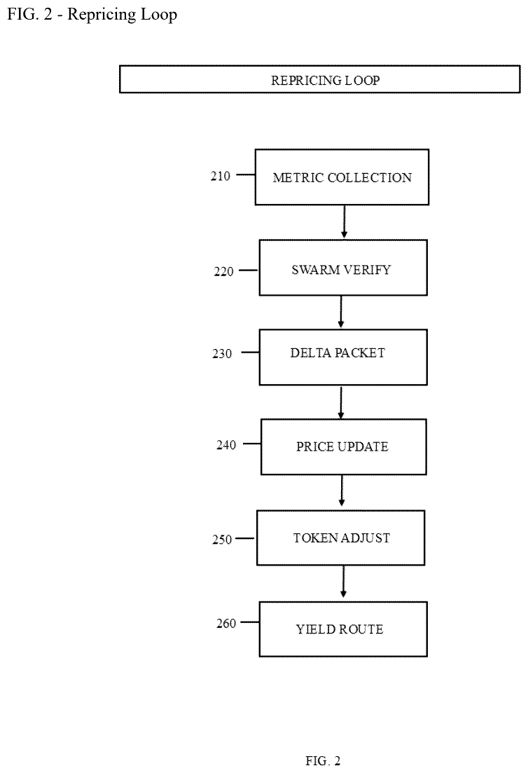

As shown in FIG. 2(a-b), a creator's engagement data is gathered through Metric Collection and verified by a Swarm Verify process involving multiple Verified Oracles.

The oracle signatures produce a SHA-256 hash that ensures integrity and tamper resistance, forming a Delta Packet for updates.

The system verifies authenticity through oracle registry checks before authorizing token adjustments or repricing.

### Token Minting Process

In FIG. 2(c-f), the Price Update and Token Adjust components mint or adjust an Influence Token compliant with ERC-721 or ERC-1155 standards, routing yields accordingly.

Embedded metadata includes creator ID, timestamp, engagement metrics, and encoded royalty logic referencing the Royalty Graph.

Tokens are tradable on decentralized exchanges supporting these standards, creating liquidity for verified influence assets.

### Royalty Automation

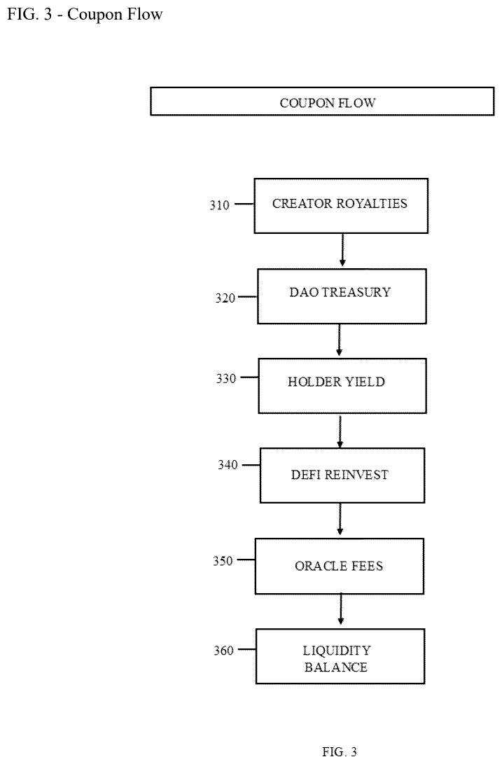

FIG. 3(a-f) depicts the coupon flow for automatic royalty-distribution, including Oracle Fees, Creator Royalties, DAO Treasury allocations, Holder Yield distributions, DeFi Reinvest options, and Liquidity Balance management.

Upon each sale or event, the Royalty Graph Smart Contract executes atomically within the transaction block, distributing funds to the creator, platform, and oracle.

Typical allocation: 1.5 % creator, 0.3 % platform, 0.2 % oracle.

Permit-based signatures remove creator gas fees, maintaining efficiency.

### EXAMPLE EMBODIMENT

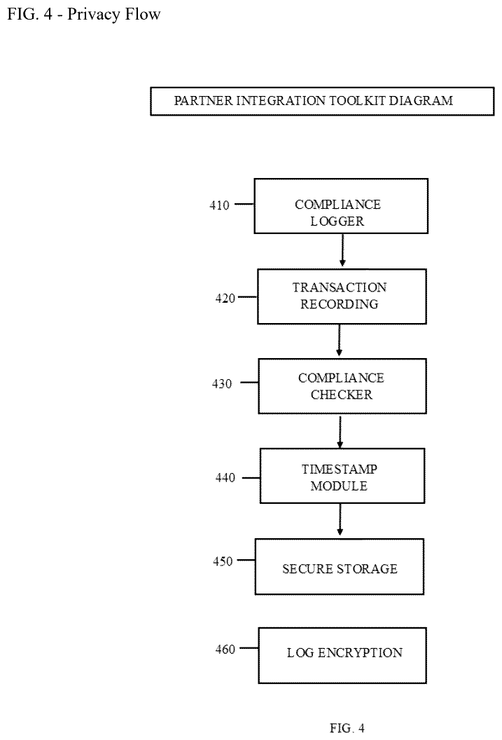

As illustrated in FIG. 4, the Partner Integration Toolkit facilitates secure interactions, with Secure Storage for data, Compliance Logger for events, Transaction Recording, Compliance Checker for validations, Timestamp Module for chronology, and Log Encryption for privacy.

In an example, Creator Alice uploads verified metrics via a social analytics oracle; the oracle signs and transmits the packet; the Token Mint Engine produces token #A102.

Buyer Bob purchases #A102 for 1 ETH. The Royalty Graph distributes 0.015 ETH to Alice, 0.003 ETH to the platform, and 0.002 ETH to the oracle, all within the same block.

The audit trail and payment proofs are immutably stored on-chain for regulatory access.

### Dispute Resolution and Compliance

Verified oracles or administrators may suspend tokens proven fraudulent.

A decentralized arbitration contract references immutable logs for transparent dispute resolution.

The Regulator Lens (FIG. 1f) aggregates event data and exports standardized financial reports for auditors.

### Optional Vault and Fractionalization Embodiment

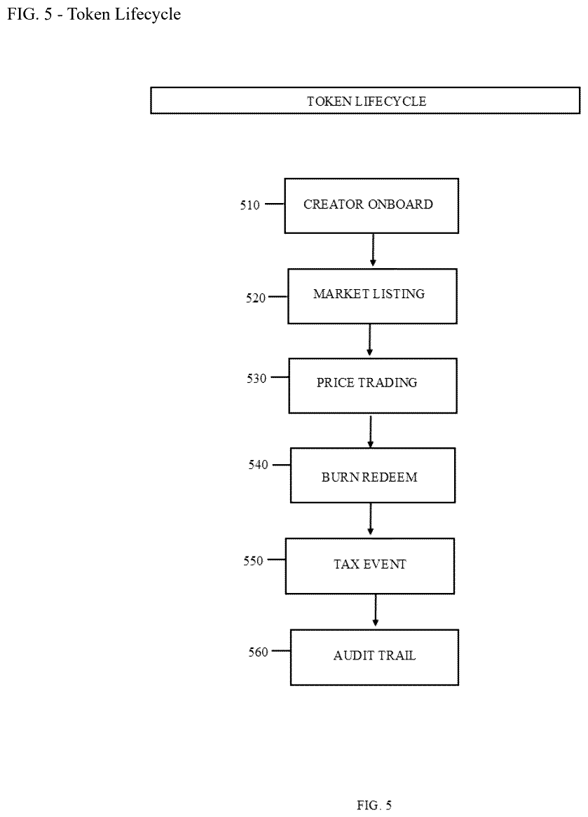

FIG. 5 shows the token lifecycle, from Creator Onboard, Market Listing, Price Trading, Burn Redeem processes, Tax Event handling, to Audit Trail maintenance.

Multiple Influence Tokens can be deposited into a Vault Layer operated by a licensed custodian, issuing fractionalized shares backed 1:1 by stored tokens under a regulated investment wrapper.

Continuous proof-of-reserve attestations appear on-chain, allowing investor verification and transparent portfolio exposure.

### Technical Implementation

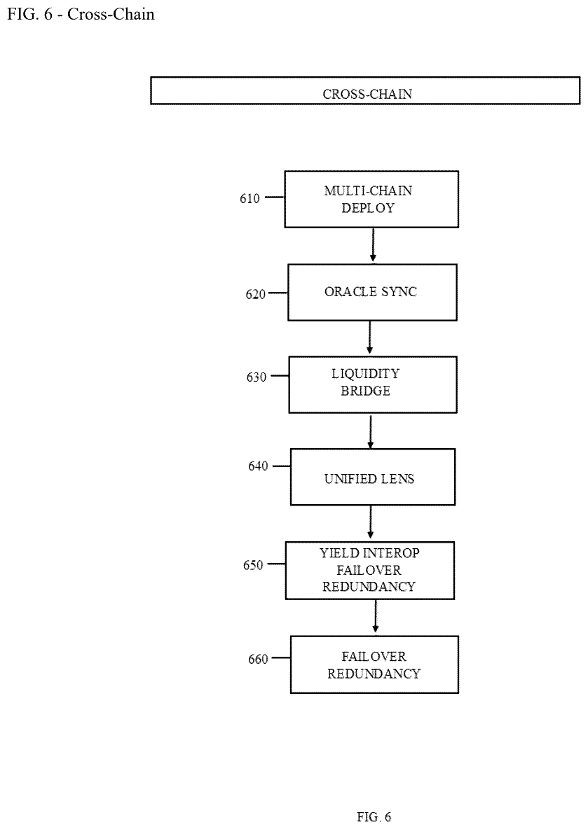

The invention executes on any EVM-compatible chain (Ethereum, Base, Polygon), with cross-chain support as shown in FIG. 6, including Multi-Chain Deploy, Oracle Sync, Liquidity Bridge, Yield Interop, Unified Lens for oversight, and Failover Redundancy.

Smart contracts are written in Solidity, utilizing SHA-256 and EIP-712 signatures.

Metadata is indexed using gas-optimized compression.

All trade and royalty records remain permanently auditable on the blockchain ledger.

1. A computer-implemented system for tokenizing verified digital influence data, comprising:
(a) a verification module receiving creator metrics and a cryptographic signature;
(b) a tokenization module generating a unique hash and minting a blockchain-based token embedding said hash and metadata;
(c) a marketplace interface listing the token for decentralized trade; and
(d) a royalty-distribution module automatically allocating a percentage of each transaction value to predefined beneficiaries.

2. A computer-implemented method for tokenizing verified digital influence data, comprising:
(a) receiving a verified dataset containing creator metrics and a cryptographic signature;
(b) generating a cryptographic hash of said dataset;
(c) minting a blockchain token embedding said hash and metadata; and
(d) listing said token for trade while executing automatic royalty distribution during each transaction.

3. A method for generating a regulated financial instrument based on the system of claim 1, comprising:
(a) depositing multiple tokens into a custodial vault;
(b) issuing fractional shares backed 1:1 by said tokens; and
(c) providing on-chain proof-of-reserve attestations under a registered investment wrapper.

4. The system of claim 1, wherein the royalty-distribution module executes atomically within the same blockchain block as the token trade.

5. The system of claim 1, wherein royalty allocation includes approximately 1.5 percent to a creator wallet, 0.3 percent to a platform treasury, and 0.2 percent to a verification oracle.

6. The system of claim 1, wherein permit-based digital signatures eliminate creator transaction fees.

7. The system of claim 1, further comprising a dispute-resolution contract permitting verified oracles to suspend invalid tokens.

8. The method of claim 2, wherein said token conforms to ERC-721 or ERC-1155 standards.

9. The method of claim 2, wherein dataset verification includes validation of a cryptographic signature from at least one authorized oracle.

10. The method of claim 3, wherein the vault provides transparent proof-of-reserve reporting to regulators and investors.

11. The system of claim 1, wherein all trade records and royalty distributions are immutably stored on-chain for compliance auditing.

12. The system of claim 1, wherein all modules operate within an Ethereum-compatible virtual-machine environment.
